(19) United States
(12) Patent Application Publication
(10) Pub. No.: US 2025/0300386 A1
(43) Pub. Date: Sep. 25, 2025

(54) CONNECTOR AND WIRE HARNESS

(71) Applicant: YAZAKI CORPORATION, Tokyo (JP)

(72) Inventors: Yuya Yamada, Makinohara-shi (JP); Minami Soga, Makinohara-shi (JP)

(21) Appl. No.: 19/061,858

(22) Filed: Feb. 24, 2025

(30) Foreign Application Priority Data
Mar. 21, 2024 (JP) 2024-044346

(51) Int. Cl. H01R 13/424

(52) U.S. Cl. CPC H01R 13/424

(57) ABSTRACT

A connector includes a terminal holder that holds one of a female terminal and a male terminal. The terminal holder includes a cylindrical portion, cutout portions provided at one end portion in an axial direction of the cylindrical portion and extending along the axial direction, and a locking portion provided at the one end portion in the axial direction of the cylindrical portion and protruding inward of the cylindrical portion in a radial direction from the one end portion in the axial direction of the cylindrical portion, one end surface of the locking portion in the axial direction being locked by a flange portion formed on an outer peripheral surface of the one terminal.

### CROSS-REFERENCE TO RELATED APPLICATION(S)

The present application claims priority to and incorporates by reference the entire contents of Japanese Patent Application No. 2024-044346 filed in Japan on Mar. 21, 2024.

### BACKGROUND OF THE INVENTION

### 1. Field of the Invention

The present invention relates to a connector and a wire harness.

### 2. Description of the Related Art

As a conventional technique related to a connector of a wire harness, for example, Japanese Patent Application Laid-open No. 2022-72046 discloses a connector including one of a female terminal and a male terminal, a terminal holder that holds the one terminal, and a housing that houses the one terminal and the terminal holder therein. The terminal holder has a plurality of cutout portions extending along an axial direction.

Meanwhile, in the connector described in Japanese Patent Application Laid-open No. 2022-72046, for example, there is room for further improvement in terms of the common use of the terminal holder between the female terminal and the male terminal having different diameters.

### SUMMARY OF THE INVENTION

The present invention has been made in view of the above circumstances, and an object of the present invention is to provide a connector and a wire harness capable of commonly using a terminal holder.

A connector according to one aspect of the present invention includes one of a female terminal and a male terminal that extends along an axial direction; a terminal holder that holds the one terminal; and a housing that houses the one terminal and the terminal holder therein, wherein the terminal holder includes: a cylindrical portion in which a terminal insertion hole is provided to allow the one terminal to be inserted thereinto along the axial direction; at least one cutout portion provided at one end portion in the axial direction of the cylindrical portion and extending along the axial direction; and a locking portion provided at the one end portion in the axial direction of the cylindrical portion and protruding inward of the cylindrical portion in the radial direction from the one end portion in the axial direction of the cylindrical portion, one end surface in the axial direction of the locking portion being locked by a flange portion formed on an outer peripheral surface of the one terminal, and the terminal holder is commonly used between the female terminal having the outer peripheral surface with a first outer diameter smaller than an inner diameter of the locking portion, and the male terminal having the outer peripheral surface with a second outer diameter larger than the inner diameter of the locking portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary exploded perspective view of a connector unit according to an embodiment;

FIG. 2 is an exemplary exploded perspective view of a mating connector of the connector unit according to the embodiment;

FIG. 3 is an exemplary exploded perspective view of a connector of the connector unit according to the embodiment;

FIG. 4 is an exemplary side view of the connector according to the embodiment;

FIG. 5 is an exemplary cross-sectional view of the connector according to the embodiment;

FIG. 6 is an exemplary side view of the mating connector according to the embodiment;

FIG. 7 is an exemplary cross-sectional view of the mating connector according to the embodiment;

FIG. 8 is an exemplary perspective view of a terminal holder of the connector according to the embodiment;

FIG. 9 is an exemplary perspective view of a terminal holder of the mating connector according to the embodiment;

FIG. 10 is an exemplary cross-sectional view of the terminal holder according to the embodiment;

FIG. 11 is an exemplary perspective view of a female terminal of the connector according to the embodiment;

FIG. 12 is an exemplary exploded perspective view of the female terminal of the connector according to the embodiment;

FIG. 13 is an exemplary perspective view of a male terminal of the mating connector according to the embodiment;

FIG. 14 is an exemplary cross-sectional view of the mating connector according to the embodiment;

FIG. 15 is an exemplary cross-sectional view of the connector according to the embodiment;

FIG. 16 is an exemplary side view of the female terminal and the terminal holder of the connector according to the embodiment;

FIG. 17 is an exemplary front view of the female terminal and the terminal holder of the connector according to the embodiment;

FIG. 18 is an exemplary cross-sectional view of the female terminal and the terminal holder of the connector according to the embodiment, and is a view illustrating a first inserting step of the terminal holder;

FIG. 19 is an exemplary cross-sectional view of the female terminal and the terminal holder of the connector according to the embodiment, and is a view illustrating a second inserting step of the terminal holder;

FIG. 20 is an exemplary cross-sectional view of the female terminal and the terminal holder of the connector according to the embodiment, and is a view illustrating a third inserting step of the terminal holder;

FIG. 21 is an exemplary cross-sectional view of the female terminal and the terminal holder of the connector according to the embodiment, and is a view illustrating a fourth inserting step of the terminal holder;

FIG. 22 is an exemplary side view of the male terminal and the terminal holder of the mating connector according to the embodiment;

FIG. 23 is an exemplary side view of the male terminal and the terminal holder of the mating connector according to the embodiment;

FIG. 24 is an exemplary cross-sectional view of the male terminal and the terminal holder of the mating connector according to the embodiment, and is a view illustrating a first inserting step of the terminal holder;

FIG. 25 is an exemplary cross-sectional view of the male terminal and the terminal holder of the mating connector according to the embodiment, and is a view illustrating a second inserting step of the terminal holder; and

FIG. 26 is an exemplary cross-sectional view of the male terminal and the terminal holder of the mating connector according to the embodiment, and is a view illustrating a third inserting step of the terminal holder.

### DETAILED DESCRIPTION OF THE PREFERRED EMBODIMENTS

Hereinafter, an embodiment according to the present invention will be described in detail with reference to the drawings. Note that the present invention is not limited by the following embodiment. In addition, the components in the following embodiment include those that can be easily replaced by those skilled in the art or those that are substantially the same. Note that, in the present specification, ordinal numbers are used only to distinguish components, members, parts, positions, directions, and the like, and do not indicate order or priority.

### Embodiment

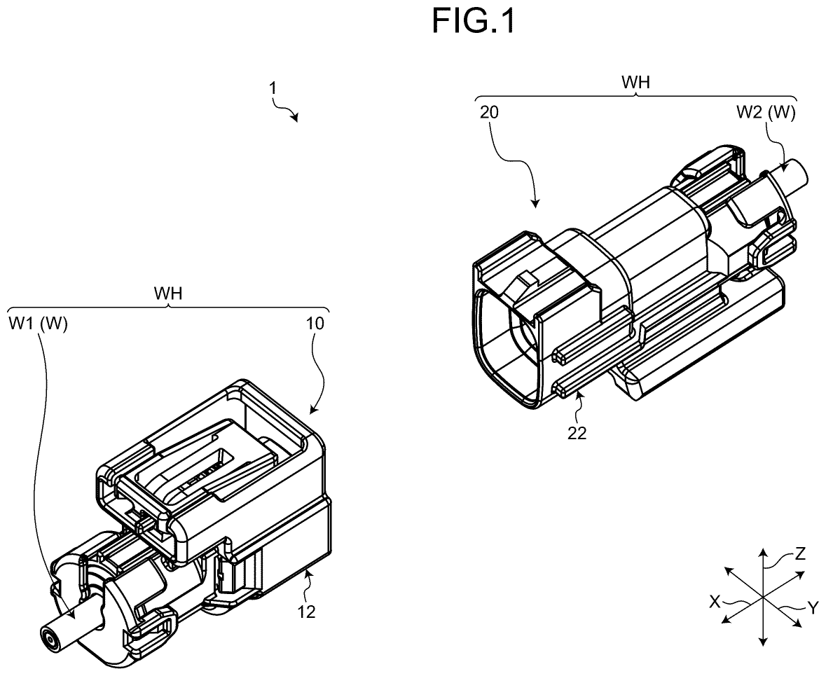

FIG. 1 is an exploded perspective view of a connector unit 1 according to an embodiment. The connector unit 1 of the present embodiment illustrated in FIG. 1 is incorporated in a wire harness WH routed in a vehicle such as an automobile. Here, the wire harness WH is configured, for example, such that wiring members W used for power supply and signal communication are bundled to form a collective component for connection between devices mounted on a vehicle, and the wiring members W are connected to the devices by connectors or the like. The wire harness WH of the present embodiment includes, for example, a plurality of wiring members W having conductivity, a connector 10 provided at an end of a first shielded wire W1 among the plurality of wiring members W, and a mating connector 20 provided at an end of a second shielded wire W2 among the plurality of wiring members W and electrically and mechanically connected to the connector 10. The wire harness WH may further include various components such as a grommet and a fixture.

In the following description, among a first direction, a second direction, and a third direction intersecting each other, the first direction will be referred to as an “axial direction X”, the second direction will be referred to as a “width direction Y”, and the third direction will be referred to as a “height direction Z”. Here, the axial direction X, the width direction Y, and the height direction Z are substantially orthogonal to each other. The axial direction X typically corresponds to an extending direction of the plurality of wiring members W, a fitting direction (insertion direction) between the connector 10 and the mating connector 20, an extending direction of a female terminal 11 and a male terminal 21 to be described later, and the like. The width direction Y typically corresponds to a width direction or the like of the connector 10 and the mating connector 20. The height direction Z typically corresponds to a height direction (vertical direction) or the like of the connector 10 and the mating connector 20. In addition, each direction used in the following description will be described as a direction in a state where the connector 10 and the mating connector 20 are assembled to the vehicle unless otherwise specified.

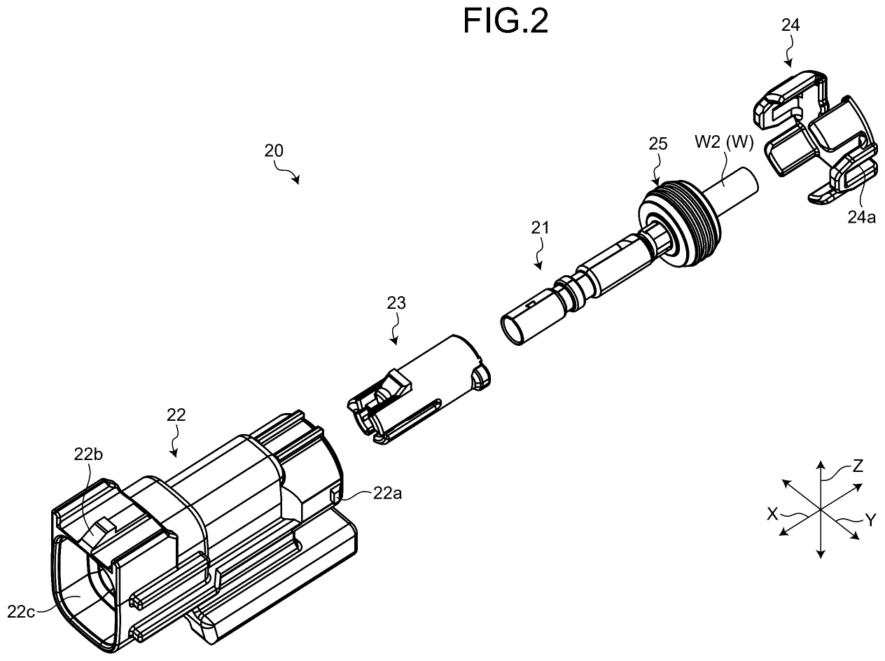

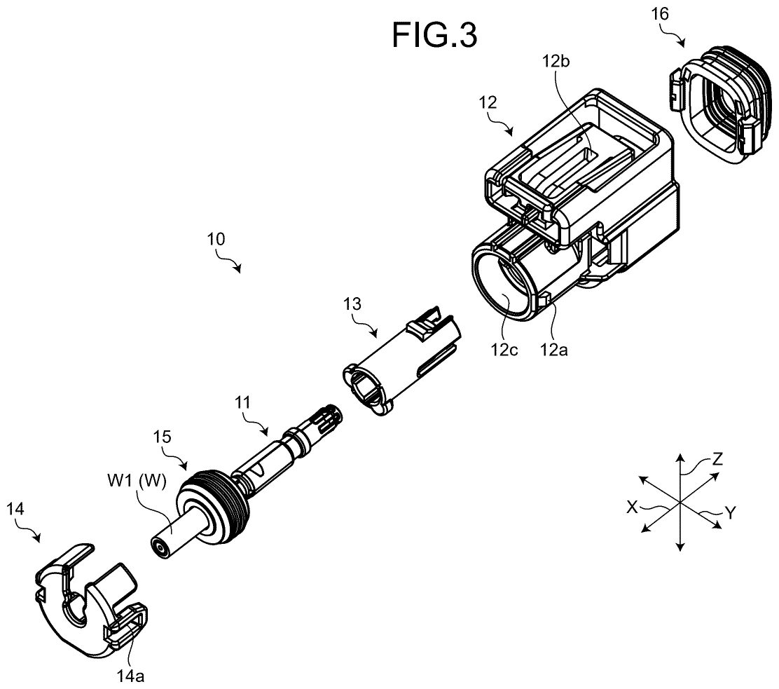

FIG. 2 is an exploded perspective view of the mating connector 20 of the connector unit 1. As illustrated in FIG. 2, the mating connector 20 includes, for example, a male terminal 21, a housing 22, a terminal holder 23, a wire seal cover 24, and a wire seal 25. The male terminal 21 is a male terminal fitting made of a conductive metal material, and is electrically connected to the female terminal 11 (see FIG. 3) of the connector 10. The male terminal 21 extends along the axial direction X, and includes, for example, an electrical connection portion electrically connected to the female terminal 11 and a wire crimping portion electrically connected to the end of the second shielded wire W2. The male terminal 21 is also referred to as a crimp terminal or the like.

The housing 22 holds the male terminal 21, the terminal holder 23, and the like therein. The housing 22 has a terminal housing chamber 22c that penetrates therethrough along the axial direction X and houses the male terminal 21, the terminal holder 23, and the like. In a state where the male terminal 21, the terminal holder 23, and the like are attached to the housing 22 inside, one end side in the axial direction X of the terminal housing chamber 22c is closed by the wire seal cover 24, and the male terminal 21 is exposed from the other end side in the axial direction X of the terminal housing chamber 22c. The housing 22 has, for example, a first locking portion 22a locking the wire seal cover 24 and a second locking portion 22b locking the connector 10. Each of the first locking portion 22a and the second locking portion 22b is formed in a claw shape on an outer surface of the housing 22. The housing 22 is formed of, for example, an insulating resin material.

The terminal holder 23 holds the male terminal 21 therein. The terminal holder 23 is formed in a cylindrical shape along an outer peripheral surface of the male terminal 21, and is engaged with the outer peripheral surface of the male terminal 21. The terminal holder 23 is inserted into the terminal housing chamber 22c of the housing 22 in a state where the terminal holder 23 is integrated with the male terminal 21. The terminal holder 23 is formed of, for example, an insulating resin material.

The wire seal cover 24 covers the terminal housing chamber 22c of the housing 22 and the wire seal 25 from one end side in the axial direction X. The wire seal cover 24 has a wire insertion hole through which the second shielded wire W2 is inserted along the axial direction X, and a locked portion 24a locked by the first locking portion 22a of the housing 22. The locked portion 24a is formed in a locking hole shape at a position corresponding to the first locking portion 22a of the wire seal cover 24. The wire seal cover 24 is integrated with the housing 22 by so-called snap-fitting, in which the locked portion 24a is locked by the first locking portion 22a, in a state where the wire seal cover 24 closes the terminal housing chamber 22c of the housing 22. The wire seal cover 24 is formed of, for example, an insulating resin material.

The wire seal 25 suppresses entry of foreign matter such as moisture into the housing 22. The wire seal 25 is formed of an elastically deformable member such as rubber or resin. The wire seal 25 is formed in, for example, a cylindrical shape along an outer peripheral surface of the second shielded wire W2, and is fitted onto the outer peripheral surface of the second shielded wire W2. The wire seal 25 is interposed between the outer peripheral surface of the second shielded wire W2 and an inner peripheral surface of the terminal housing chamber 22c of the housing 22 in a state where the second shielded wire W2 is attached to the housing 22 inside.

FIG. 3 is an exploded perspective view of the connector 10 of the connector unit 1. As illustrated in FIG. 3, the connector 10 includes, for example, a female terminal 11, a housing 12, a terminal holder 13, a wire seal cover 14, a wire seal 15, and a packing 16. The female terminal 11 is a female terminal fitting made of a conductive metal material, and is electrically connected to the male terminal 21 of the mating connector 20 described above. The female terminal 11 extends along the axial direction X, and includes, for example, an electrical connection portion electrically connected to the male terminal 21 and a wire crimping portion electrically connected to the end of the first shielded wire W1. The female terminal 11 is also referred to as a crimp terminal or the like.

The housing 12 holds the female terminal 11, the terminal holder 13, and the like therein. The housing 12 has a terminal housing chamber 12c that penetrates therethrough along the axial direction X and houses the female terminal 11, the terminal holder 13, and the like. In a state where the female terminal 11, the terminal holder 13, and the like are attached to the housing 12 inside, the other end side in the axial direction X of the terminal housing chamber 12c is closed by the wire seal cover 14, and the female terminal 11 is exposed from one end side in the axial direction X of the terminal housing chamber 12c. The housing 12 has, for example, a locking portion 12a locking the wire seal cover 14 and a locked portion 12b locked by the second locking portion 22b of the mating connector 20 described above. The housing 12 is formed of, for example, an insulating resin material.

The terminal holder 13 holds the female terminal 11 therein. The terminal holder 13 is formed in a cylindrical shape along an outer peripheral surface of the female terminal 11, and is engaged with the outer peripheral surface of the female terminal 11. The terminal holder 13 is inserted into the terminal housing chamber 12c of the housing 12 in a state where the terminal holder 13 is integrated with the female terminal 11. The terminal holder 13 is formed of, for example, an insulating resin material.

The wire seal cover 14 covers the terminal housing chamber 12c of the housing 12 and the wire seal 15 from the other end side in the axial direction X. The wire seal cover 14 has a wire insertion hole through which the first shielded wire W1 is inserted along the axial direction X, and a locked portion 14a locked by the locking portion 12a of the housing 12. The locked portion 14a is formed in a locking hole shape at a position corresponding to the locking portion 12a of the wire seal cover 14. The wire seal cover 14 is integrated with the housing 12 by so-called snap-fitting, in which the locked portion 14a is locked by the locking portion 12a, in a state where the wire seal cover 14 closes the terminal housing chamber 12c of the housing 12. The wire seal cover 14 is formed of, for example, an insulating resin material.

The wire seal 15 suppresses entry of foreign matter such as moisture into the housing 12. The wire seal 15 is formed of an elastically deformable member such as rubber or resin. The wire seal 15 is formed in, for example, a cylindrical shape along an outer peripheral surface of the first shielded wire W1, and is fitted onto the outer peripheral surface of the first shielded wire W1. The wire seal 15 is interposed between the outer peripheral surface of the first shielded wire W1 and an inner peripheral surface of the terminal housing chamber 12c of the housing 12 in a state where the first shielded wire W1 is attached to the housing 12 inside.

The packing 16 suppresses entry of foreign matter such as moisture into the housing 12. The packing 16 is formed of an elastically deformable member such as rubber or resin. For example, the packing 16 is formed in a substantially rectangular tubular shape along an outer peripheral surface of an outer tubular portion 12g (see FIG. 5) of the housing 12, and is fitted onto the outer peripheral surface of the outer tubular portion 12g. The packing 16 is interposed between the outer peripheral surface of the outer tubular portion 12g and an open end portion 22g (see FIG. 7) of the terminal housing chamber 22c of the mating connector 20 in a state where the connector 10 and the mating connector 20 are connected to each other. The second locking portion 22b described above is provided at the open end portion 22g.

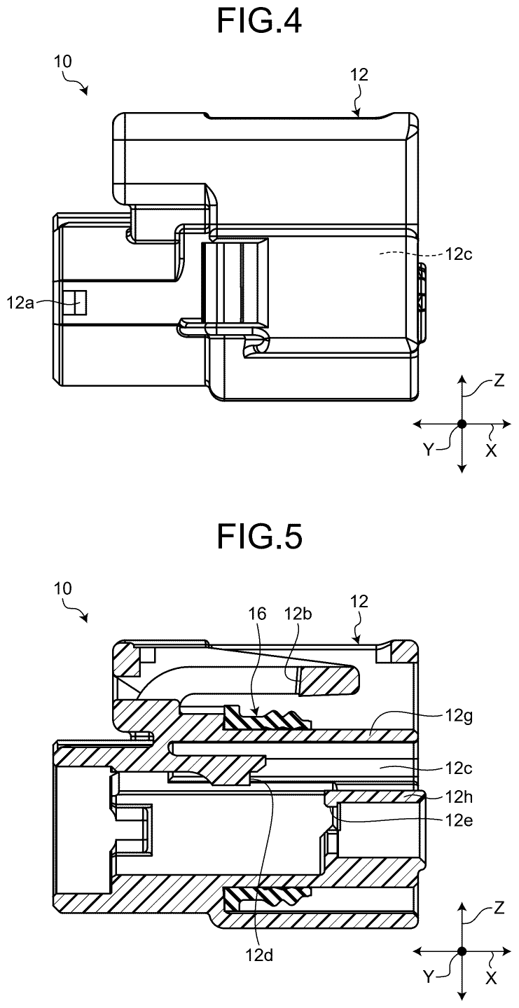

FIG. 4 is a side view of the connector 10, and FIG. 5 is a cross-sectional view of the connector 10. As illustrated in FIGS. 4 and 5, a lance portion 12d and a penetration prevention wall 12e are provided in the terminal housing chamber 12c of the housing 12. The lance portion 12d locks the female terminal 11 and the terminal holder 13 described above along the axial direction X. For example, the lance portion 12d is connected to the outer tubular portion 12g of the housing 12, and extends in parallel with the outer tubular portion 12g inside the outer tubular portion 12g. That is, the lance portion 12d is provided to protrude along the axial direction X in the terminal housing chamber 12c, and one end surface in the axial direction X of the lance portion 12d is locked by the female terminal 11 and the terminal holder 13. The lance portion 12d is partially provided, for example, along a circumferential direction of the outer tubular portion 12g.

The penetration prevention wall 12e prevents the female terminal 11 and the terminal holder 13 from protruding from the terminal housing chamber 12c along the axial direction X. The penetration prevention wall 12e protrudes along the height direction Z (radial direction), for example, from an inner tubular portion 12h of the housing 12. The inner tubular portion 12h is a tubular wall positioned inside the outer tubular portion 12g, and is a portion into which leading end portions of the female terminal 11 and the terminal holder 13 are inserted. The penetration prevention wall 12e is positioned not to overlap the lance portion 12d along the height direction Z but to be shifted to one end side along the axial direction X. The penetration prevention wall 12e is provided at the other end portion (an end portion opposite to the open end portion) in the axial direction X of the inner tubular portion 12h, and is formed in, for example, a shape like a flange continuously provided along the circumferential direction of the inner tubular portion 12h.

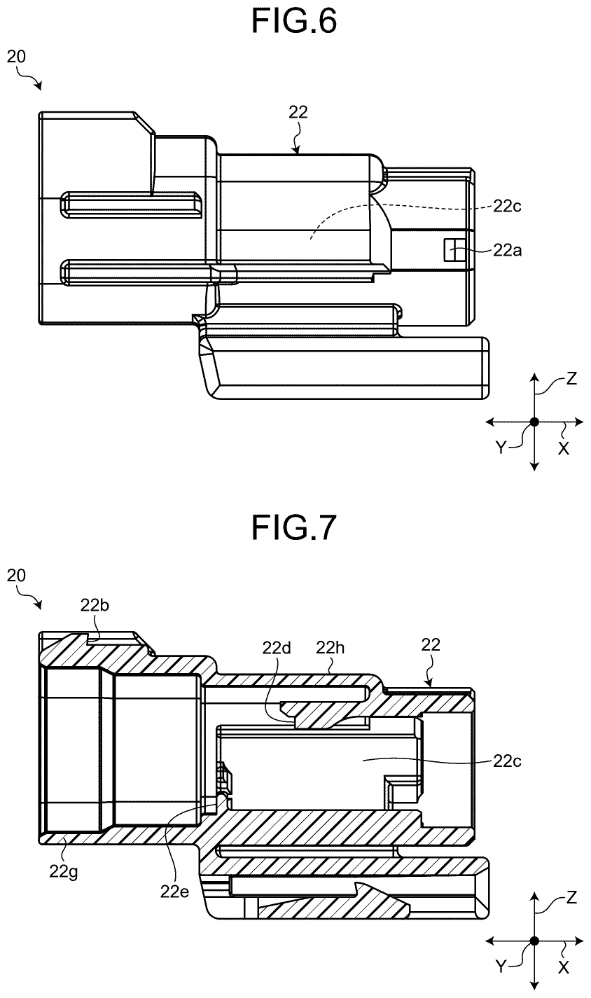

FIG. 6 is a side view of the mating connector 20, and FIG. 7 is a cross-sectional view of the mating connector 20. As illustrated in FIGS. 6 and 7, a lance portion 22d and a penetration prevention wall 22e are provided in the terminal housing chamber 22c of the housing 22, similarly to that in the connector 10. The lance portion 22d locks the male terminal 21 and the terminal holder 23 described above along the axial direction X. For example, the lance portion 22d is connected to an outer tubular portion 22h of the housing 22, and extends in parallel with the outer tubular portion 22h inside the outer tubular portion 22h. That is, the lance portion 22d is provided to protrude along the axial direction X in the terminal housing chamber 22c, and the other end surface in the axial direction X of the lance portion 22d is locked by the male terminal 21 and the terminal holder 23. The lance portion 22d is partially provided, for example, along the circumferential direction of the outer tubular portion 22h.

The penetration prevention wall 22e suppresses the male terminal 21 and terminal holder 23 from protruding from the terminal housing chamber 22c along the axial direction X. The penetration prevention wall 22e protrudes along the height direction Z (radial direction), for example, from a portion of the outer tubular portion 22h of the housing 22 opposite to the lance portion 22d. In addition, the penetration prevention wall 22e is positioned not to overlap the lance portion 22d along the height direction Z but to be shifted to the other end side along the axial direction X. The penetration prevention wall 12e is partially provided, for example, along the circumferential direction of the outer tubular portion 22h.

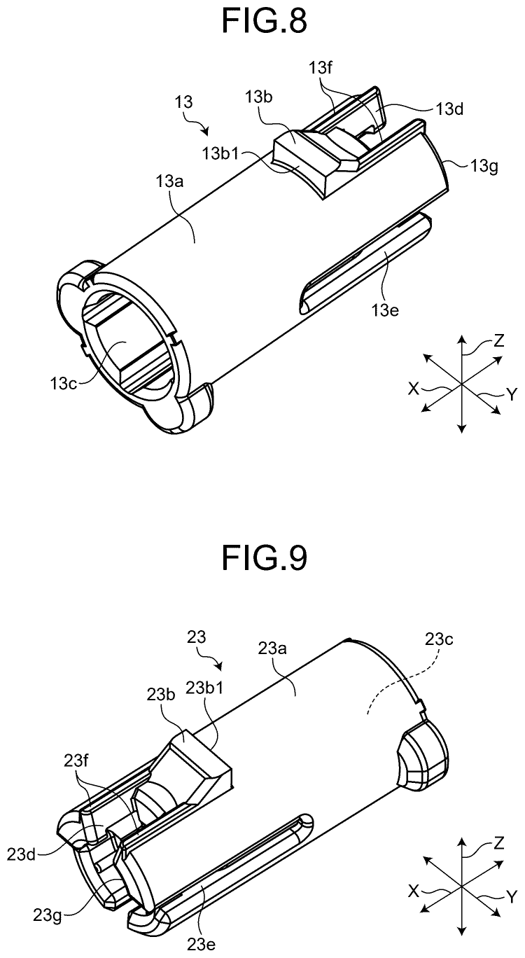

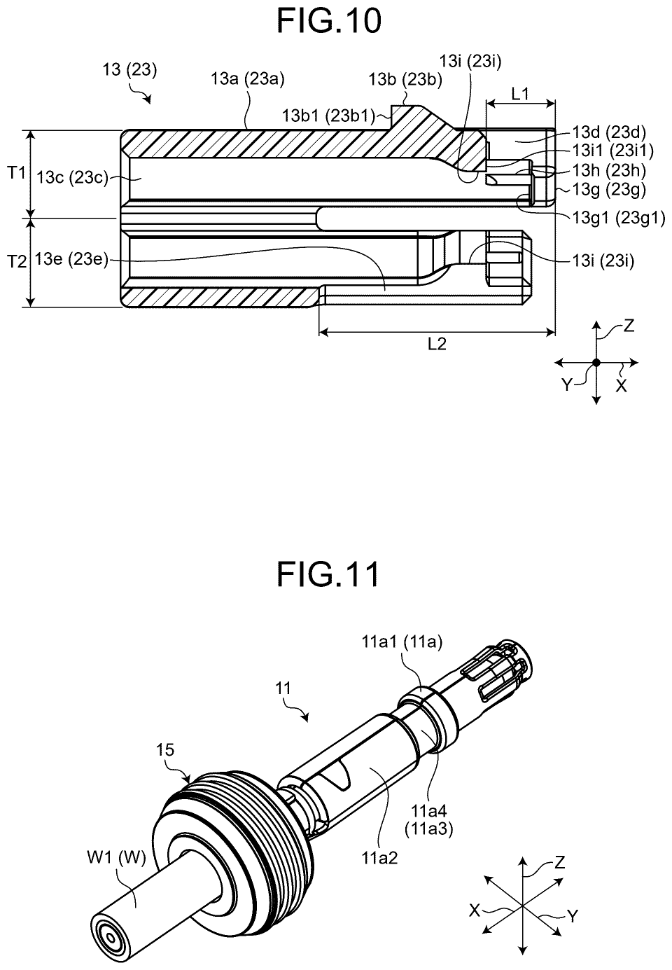

FIG. 8 is a perspective view of the terminal holder 13 of the connector 10, FIG. 9 is a perspective view of the terminal holder 23 of the mating connector 20, and FIG. 10 is a cross-sectional view of the terminal holders 13 and 23. As illustrated in FIGS. 8 to 10, in the present embodiment, the terminal holder 13 of the connector 10 and the terminal holder 23 of the mating connector 20 are configured by the same components. That is, the specifications of the terminal holder 13 are the same as the specifications of the terminal holder 23, and the terminal holders 13 and 23 can be used interchangeably. The terminal holder 13 or 23 includes, for example, a cylindrical portion 13a or 23a, a locking projection portion 13b or 23b, a first cutout portion 13d or 23d and a second cutout portion 13e or 23e as cutout portions, a positioning rib 13f or 23f, a stopper portion 13g or 23g, a rib 13h or 23h, and a locking portion 131 or 231.

The cylindrical portion 13a or 23a holds the female terminal 11 or the male terminal 21 described above inside. The cylindrical portion 13a or 23a has a terminal insertion hole 13c or 23c that penetrates therethrough along the axial direction X to allow the female terminal 11 or the male terminal 21 to be inserted thereinto. The cylindrical portion 13a or 23a is formed in a cylindrical shape along the outer peripheral surface of the female terminal 11 or the male terminal 21, and is engaged with the outer peripheral surface of the female terminal 11 or the male terminal 21.

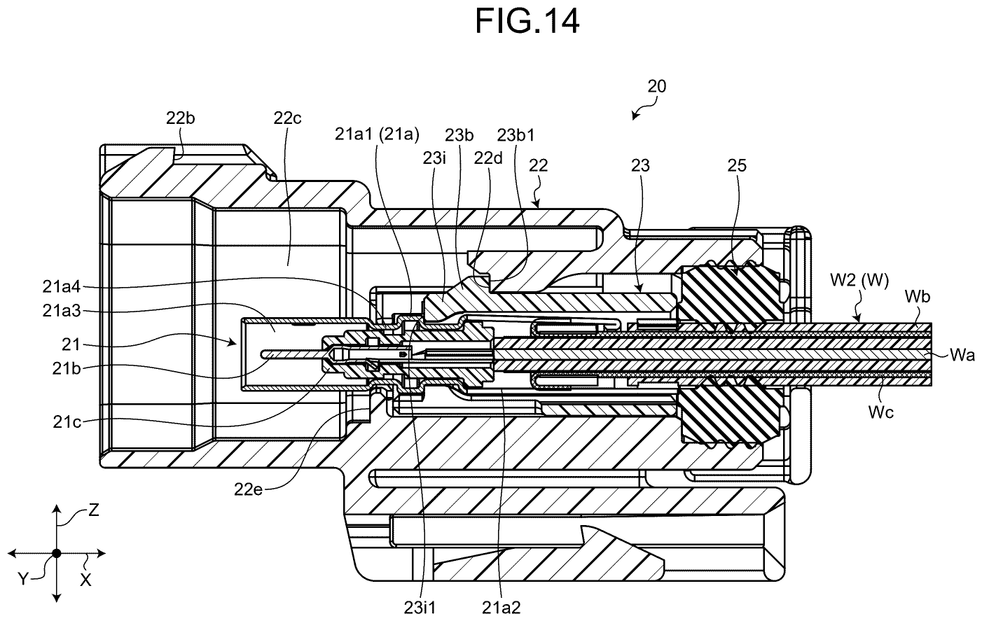

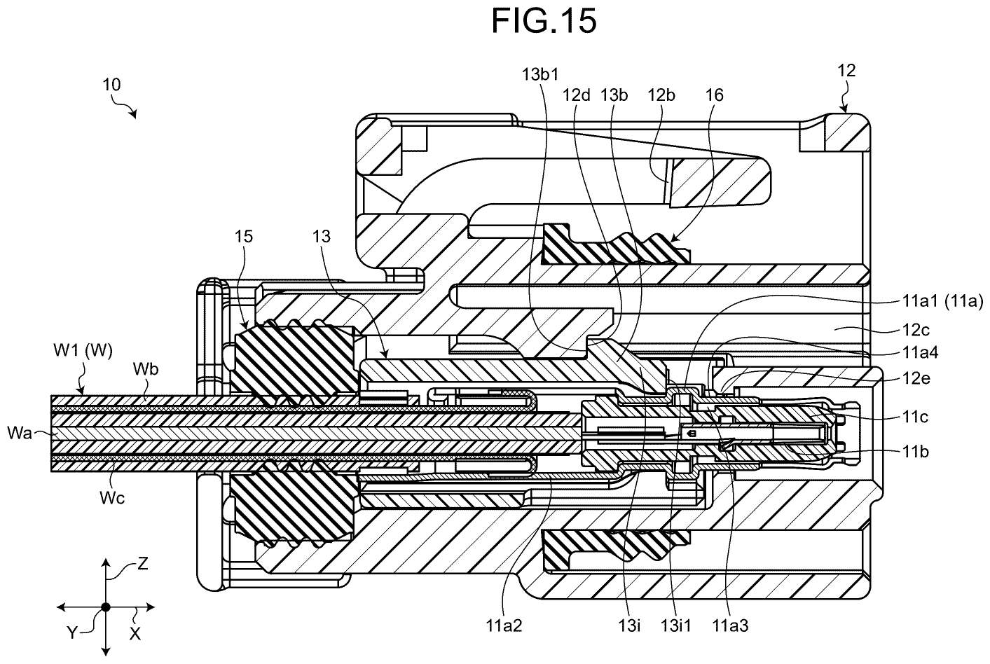

The locking projection portion 13b or 23b is locked by the lance portion 12d or 22d formed inside the housing 12 or 22 described above. The locking projection portion 13b is provided at one end portion in the axial direction X of the cylindrical portion 13a, and projects outward of the cylindrical portion 13a in the radial direction from one end portion of the cylindrical portion 13a. The locking projection portion 23b is provided at the other end portion in the axial direction X of the cylindrical portion 23a, and projects outward of the cylindrical portion 23a in the radial direction from the other end portion of the cylindrical portion 23a. That is, the terminal holders 13 and 23 are assembled to the terminal housing chambers 12c and 22c (see FIGS. 14 and 15) of the housings 12 and 22 in postures inverted relative to each other along the axial direction X. The other end surface 13b1 of the locking projection portion 13b in the axial direction X is locked by the lance portion 12d of the housing 12, and one end surface 23b1 of the locking projection portion 23b in the axial direction X is locked by the lance portion 22d of the housing 22.

The first cutout portion 13d or 23d and the second cutout portions 13e or 23e control the bending amount (deformation amount) of the terminal holder 13 or 23. The first cutout portion 13d or 23d and the second cutout portions 13e or 23e are provided at an end portion of the cylindrical portion 13a or 23a on the locking projection portion 13b or 23b side, and extends along the axial direction X. In the present embodiment, one first cutout portion 13d or 23d and three second cutout portions 13e or 23e spaced apart from each other in the circumferential direction of the cylindrical portion 13a or 23a are provided in the cylindrical portion 13a or 23a. A length L2 (see FIG. 10) of each of the second cutout portions 13e or 23e along the axial direction X is larger than a length L1 of the first cutout portion 13d or 23d along the axial direction X.

In the present embodiment, when viewed from the width direction Y, the one first cutout portion 13d or 23d is provided in an upper region T1 as a first region closer to one end portion than the central portion in the height direction Z at one end portion or the other end portion of the cylindrical portion 13a or 23a. On the other hand, when viewed from the width direction Y, the three second cutout portions 13e or 23e are provided in a lower region T2 as a second region closer to the other end portion than the central portion in the height direction Z at one end portion or the other end portion of the cylindrical portion 13a or 23a. In the present embodiment, in addition to the first cutout portion 13d or 23d described above, the locking projection portion 13b or 23b, the positioning rib 13f or 23f, the stopper portion 13g and 23g, and the like are provided in the upper region T1. The locking portion 13i or 23i and the rib 13h or 23h are provided across the upper region T1 and the lower region T2. As described above, in the present embodiment, by providing the first cutout portion 13d or 23d and the plurality of second cutout portions 13e or 23e in the terminal holder 13 or 23, there is a difference in bending amount (deformation amount) between the upper region T1 and the lower region T2 in the cylindrical portion 13a or 23a.

The positioning ribs 13f and 23f (see FIGS. 8 and 9) function as guides when the terminal holders 13 and 23 are inserted into the respective housings 12 and 22. The positioning ribs 13f or 23f are provided at both end portions in the width direction Y of the first cutout portion 13d or 23d, and protrude from the both end portions outward of the cylindrical portion 13a or 23a in the radial direction. The positioning ribs 13f and 23f are aligned with the above-described lance portions 12d and 22d (see FIGS. 14 and 15) when the terminal holders 13 and 23 are inserted into the respective housings 12 and 22, thereby positioning the terminal holders 13 and 23 along the circumferential directions of the cylindrical portions 13a and 23a with respect to the respective housings 12 and 22.

The rib 13h or 23h (see FIG. 10) has a function of centering the female terminal 11 or the male terminal 21 toward the center of the cylindrical portion 13a or 23a. The rib 13h or 23h is provided at one end portion or the other end portion in the axial direction X of the cylindrical portion 13a or 23a, and protrudes inward of the cylindrical portion 13a or 23a in the radial direction from the upper region T1 and the lower region T2. That is, in the present embodiment, a plurality of ribs 13h or 23h spaced apart from each other in the circumferential direction of the cylindrical portion 13a or 23a are provided on the terminal holder 13 or 23.

The locking portion 13i or 23i is locked by a flange portion 11a1 or 21a1 (see FIGS. 11 and 13) formed on the outer peripheral surface of the female terminal 11 or the male terminal 21 to be described later. The locking portion 13i or 23i is provided at one end portion or the other end portion in the axial direction X of the cylindrical portion 13a or 23a, and protrudes inward of the cylindrical portion 13a or 23a in the radial direction from the upper region T1 and the lower region T2. That is, the locking portion 131 or 23i is formed in a substantially annular shape along an inner peripheral surface of the cylindrical portion 13a or 23a. Note that the locking portion 13i or 23i is circumferentially divided at portions where the second cutout portions 13e or 23e described above are provided in the circumferential direction of the cylindrical portion 13a or 23a. The locking portion 13i or 23i is provided, for example, at a leading end portion of the locking projection portion 13b or 23b on the stopper portion 13g or 23g side (a bottom portion of the first cutout portion 13d). One end surface 13i1 of the locking portion 13i in the axial direction X is locked by the flange portion 11a1, and the other end surface 23i1 of the locking portion 23i in the axial direction X is locked by the flange portion 21a1. The locking portion 131 or 23i restricts a movement of the female terminal 11 or the male terminal 21 in the axial direction X with respect to the cylindrical portion 13a or 23a by abutting on the flange portion 11a1 or 21a1.

The stopper portion 13g or 23g is locked by the flange portion 11a1 or 21a1 (see FIGS. 11 and 13) described above. The stopper portion 13g or 23g is provided at one end portion or the other end portion in the axial direction X of the cylindrical portion 13a or 23a, and protrudes inward of the cylindrical portion 13a or 23a in the radial direction from the upper region T1. That is, the stopper portion 13g or 23g is partially provided in the upper region T1 in the circumferential direction of the cylindrical portion 13a or 23a, and is positioned to be spaced apart from the locking portion 13i or 23i in the axial direction X. The other end surface 13g1 of the stopper portion 13g in the axial direction X is locked by the flange portion 11a1, and one end surface 23g1 of the stopper portion 23g is locked by the flange portion 21a1. That is, the stopper portion 13g or 23g is locked to sandwich the flange portion 11a1 or 21a1 between the stopper portion 13g or 23g and the locking portion 13i or 23i in the axial direction X. The stopper portion 13g or 23g restricts a movement of the female terminal 11 or the male terminal 21 in the axial direction X with respect to the cylindrical portion 13a or 23a by abutting on the flange portion 11a1 or 21a1.

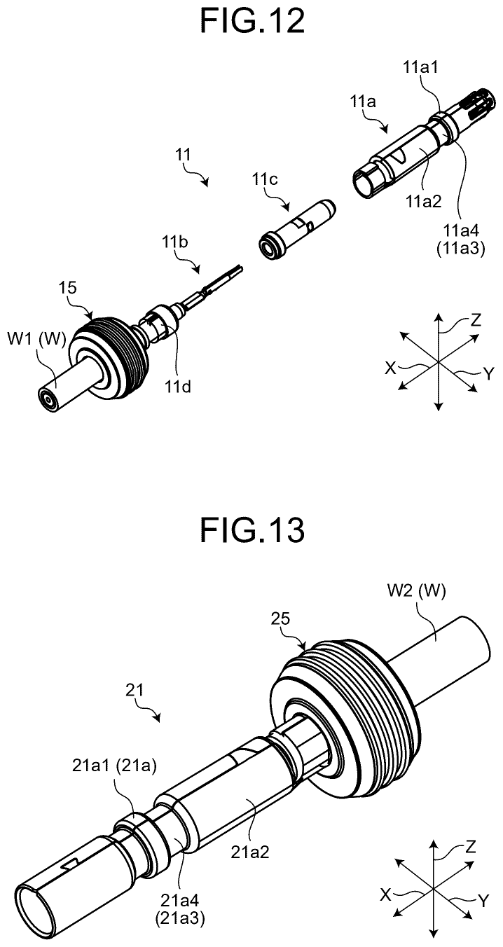

FIG. 11 is a perspective view of the female terminal 11 of the connector 10, and FIG. 12 is an exploded perspective view of the female terminal 11 of the connector 10. As illustrated in FIGS. 11 and 12, the female terminal 11 includes, for example, an outer terminal 11a, an inner terminal 11b, an inner housing 11c, and a sleeve 11d. The outer terminal 11a is a shield terminal conductively connected to a braided member Wc (see FIG. 15) of the first shielded wire W1 to exhibit a function of shielding the inner terminal 11b. The outer terminal 11a has an inner terminal housing space 11a3 for housing the inner terminal 11b therein.

The flange portion 11a1 is provided on the outer terminal 11a. The flange portion 11a1 is provided on a wall surface 11a4 in a portion where the inner terminal housing space 11a3 is formed of the outer terminal 11a, and protrudes in an annular shape (in a ring shape) outward of the outer terminal 11a in the radial direction from the wall surface 11a4. In the present embodiment, the outer terminal 11a does not have a hole or the like penetrating through the cylindrical wall surface 11a4 along the radial direction, and the wall surface 11a4 shields the inner terminal 11b housed in the inner terminal housing space 11a3 in the radial direction from an external space.

In addition, the outer terminal 11a has a pair of barrel pieces 11a2. The pair of barrel pieces 11a2 are portions caulked and crimped to the end of the first shielded wire W1. The pair of barrel pieces 11a2 is formed integrally with the wall surface 11a4 and the flange portion 11a1. The pair of barrel pieces 11a2 has a substantially U-shaped cross-sectional shape in a state before the outer terminal 11a is crimped.

The inner terminal 11b is a normal terminal conductively connected to a conductor portion Wa (see FIG. 15) of the first shielded wire W1. The inner terminal 11b is held by the inner housing 11c. The inner housing 11c holds the inner terminal 11b therein. The inner housing 11c has a terminal insertion hole that penetrates therethrough along the axial direction X to allow the inner terminal 11b to be inserted thereinto. The inner housing 11c is inserted into the inner terminal housing space 11a3 of the outer terminal 11a in a state where the inner housing 11c is integrated with the inner terminal 11b. The inner housing 11c is formed of, for example, an insulating resin material.

The sleeve 11d functions as, for example, a shield ring (caulking ring) crimped to the braided member Wc of the first shielded wire W1. The sleeve 11d is formed by pressing a metal plate into a predetermined shape. The sleeve 11d is formed, for example, in substantially the same manner as the pair of barrel pieces 11a2 described above. That is, the sleeve 11d has a substantially U-shaped cross-sectional shape before being crimped. The female terminal 11 is also referred to as a female terminal assembly or the like.

FIG. 13 is a perspective view of the male terminal 21 of the mating connector 20. FIG. 14 is a cross-sectional view of the mating connector 20. As illustrated in FIGS. 13 and 14, similarly to the female terminal 11, the male terminal 21 includes, for example, an outer terminal 21a, an inner terminal 21b (see FIG. 14), an inner housing 21c, and a sleeve. The outer terminal 21a is a shield terminal conductively connected to a braided member Wc of the second shielded wire W2 to exhibit a function of shielding the inner terminal 21b. The outer terminal 21a has an inner terminal housing space 21a3 for housing the inner terminal 21b therein.

The flange portion 21a1 is provided on the outer terminal 21a. The flange portion 21a1 is provided on a wall surface 21a4 in a portion where the inner terminal housing space 21a3 is formed of the outer terminal 21a, and protrudes in an annular shape (in a ring shape) outward of the outer terminal 21a in the radial direction from the wall surface 21a4. In the present embodiment, the outer terminal 21a does not have a hole or the like penetrating through the cylindrical wall surface 21a4 along the radial direction, and the wall surface 21a4 shields the inner terminal 21b housed in the inner terminal housing space 21a3 in the radial direction from an external space.

The outer terminal 21a has a pair of barrel pieces 21a2. The pair of barrel pieces 21a2 are portions caulked and crimped to the end of the second shielded wire W2. The pair of barrel pieces 21a2 is formed integrally with the wall surface 21a4 and the flange portion 21a1. The pair of barrel pieces 21a2 has a substantially U-shaped cross-sectional shape before the outer terminal 21a is crimped.

The inner terminal 21b is a normal terminal conductively connected to a conductor portion Wa (see FIG. 14) of the second shielded wire W2. The inner terminal 21b is held by the inner housing 21c. The inner housing 21c holds the inner terminal 21b therein. The inner housing 21c has a terminal insertion hole that penetrates therethrough along the axial direction X to allow the inner terminal 21b to be inserted thereinto. The inner housing 21c is inserted into the inner terminal housing space 21a3 of the outer terminal 21a in a state where the inner housing 21c is integrated with the inner terminal 21b. The inner housing 21c is formed of, for example, an insulating resin material.

The sleeve functions as, for example, a shield ring (caulking ring) crimped to the braided member Wc of the second shielded wire W2. The sleeve is formed substantially similarly to the sleeve 11d of the female terminal 11 described above. The male terminal 21 is also referred to as a male terminal assembly or the like. Note that the braided member Wc is formed by weaving a conductive metal material, and is assembled in a state where a part of the second shielded wire W2 is housed inside. The braided member Wc includes, for example, an outer shield portion and an inner shield portion connected to the outer shield portion via a folded portion. In the present embodiment, the inner shield portion covers the conductor portion Wa and the insulating sheath Wb of the second shielded wire W2 over substantially the entire length of the second shielded wire W2, whereby the wiring member W is configured as the second shielded wire W2.

Here, in the present embodiment, in a state where the male terminal 21 and the terminal holder 23 are assembled to the housing 22, one end surface 23b1 of the locking projection portion 23b in the axial direction X is locked by the lance portion 22d of the housing 22, and the other end surface 23i1 of the locking portion 23i in the axial direction X is locked by the flange portion 21a1 of the male terminal 21. That is, in the present embodiment, the male terminal 21 is locked against the lance portion 22d of the housing 22 along the axial direction X at two positions, the other end surface 23i1 of the locking portion 23i and one end surface 23b1 of the locking projection portion 23b. As a result, the force for holding the male terminal 21 can be increased, and eventually, the male terminal 21 can be suppressed from coming off the housing 22 when the second shielded wire W2 is pulled along the axial direction X.

FIG. 15 is a cross-sectional view of the connector 10. As illustrated in FIG. 15, in the present embodiment, the braided member Wc of the first shielded wire W1 is also formed by weaving a conductive metal material, and is assembled in a state where a part of the first shielded wire W1 is housed inside. The braided member Wc includes, for example, an outer shield portion and an inner shield portion connected to the outer shield portion via a folded portion. In the present embodiment, the inner shield portion covers the conductor portion Wa and the insulating sheath Wb of the first shielded wire W1 over substantially the entire length of the first shielded wire W1, whereby the wiring member W is configured as the first shielded wire W1.

In the present embodiment, in a state where the female terminal 11 and the terminal holder 13 are assembled to the housing 12, the other end surface 13b1 of the locking projection portion 13b in the axial direction X is locked by the lance portion 12d of the housing 12, and one end surface 13i1 of the locking portion 13i in the axial direction X is locked by the flange portion 11a1 of the female terminal 11. That is, in the present embodiment, the female terminal 11 is locked against the lance portion 12d of the housing 12 along the axial direction X at two positions, one end surface 13i1 of the locking portion 13i and the other end surface 13b1 of the locking projection portion 13b. As a result, the force for holding the female terminal 11 can be increased, and eventually, the female terminal 11 can be suppressed from coming off the housing 12 when the first shielded wire W1 is pulled along the axial direction X.

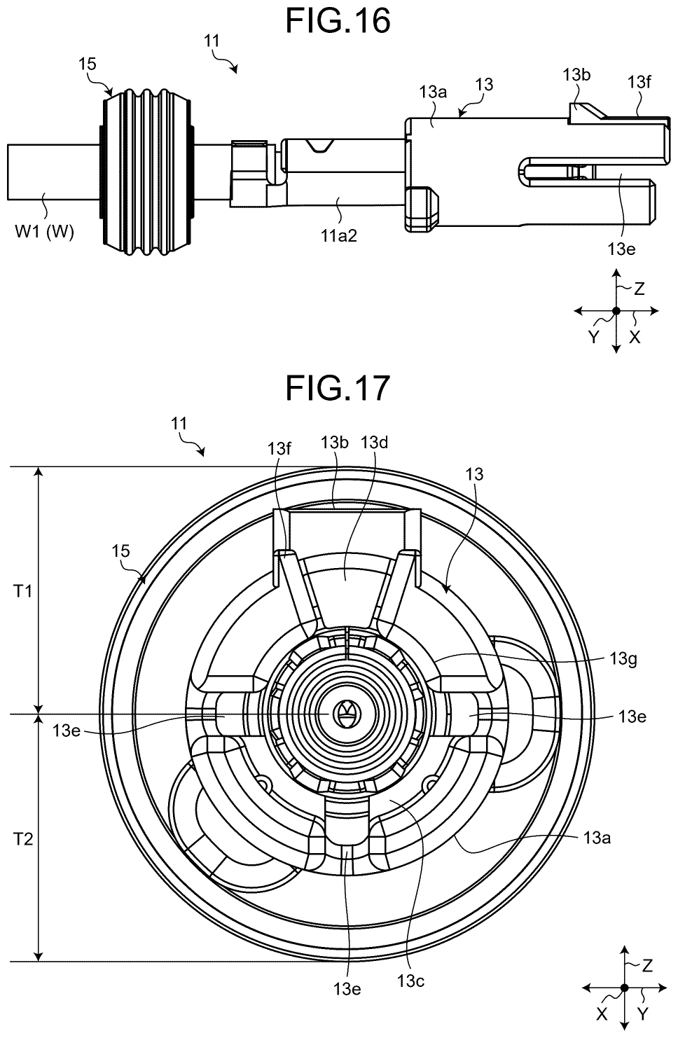

FIG. 16 is a side view of the female terminal 11 and the terminal holder 13 of the connector 10, and FIG. 17 is a front view of the female terminal 11 and the terminal holder 13 of the connector 10. As illustrated in FIGS. 16 and 17, in the present embodiment, the female terminal 11 is inserted into the terminal insertion hole 13c formed inside the terminal holder 13 along the axial direction X. At this time, in the present embodiment, the one first cutout portion 13d, the locking projection portion 13b, the pair of positioning ribs 13f, the pair of stopper portions 13g, and the like described above are provided in the upper region T1 of the cylindrical portion 13a. On the other hand, the three second cutout portions 13e longer than the first cutout portion 13d described above in the axial direction X are provided to be spaced apart from each other in the circumferential direction of the cylindrical portion 13a in the lower region T2 of the cylindrical portion 13a.

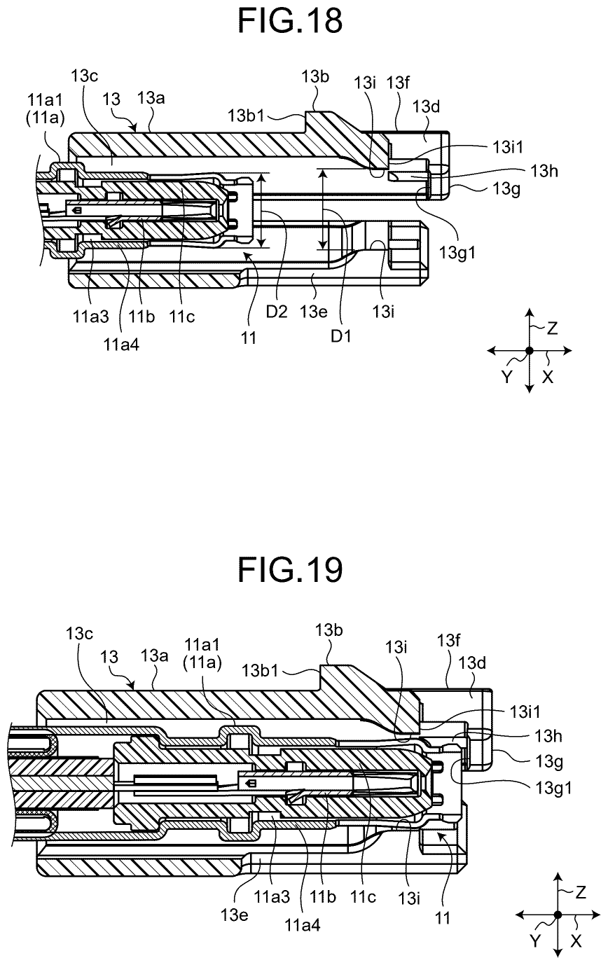

Therefore, in the present embodiment, the upper region T1 is less likely to bend along the radial direction of the cylindrical portion 13a with respect to the lower region T2. That is, the upper region T1 functions as a portion where a bending amount (deformation amount) is relatively small, and the lower region T2 functions as a portion where a bending amount (deformation amount) is relatively large. In the present embodiment, the rib 13h and the locking portion 13i (see FIG. 18) described above are provided across the upper region T1 and the lower region T2. Therefore, the locking portion 13i provided in the upper region T1 is less likely to bend than the locking portion 13i provided in the lower region T2.

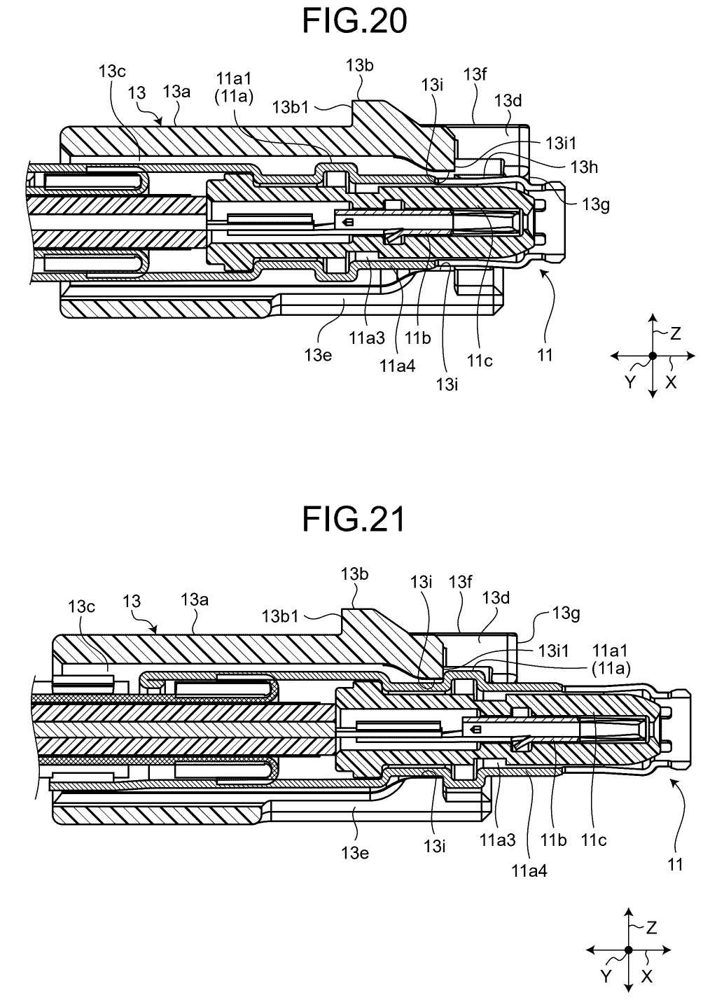

FIGS. 18 to 21 are cross-sectional views of the female terminal 11 and the terminal holder 13 of the connector 10, FIG. 18 is a view illustrating a first inserting step of the terminal holder 13, FIG. 19 is a view illustrating a second inserting step of the terminal holder 13, FIG. 20 is a view illustrating a third inserting step of the terminal holder 13, and FIG. 21 is a view illustrating a fourth inserting step of the terminal holder 13. First, in the first inserting step (see FIG. 18) of the terminal holder 13, the leading end portion of the female terminal 11 is inserted from the open end portion on the other end side in the axial direction X of the terminal insertion hole 13c. In this state, the locking portion 13i and the leading end portion of the female terminal 11 are spaced apart from each other in the axial direction X.

Next, in the second inserting step (see FIG. 19) of the terminal holder 13, the leading end portion of the female terminal 11 is inserted into the locking portion 13i. In this state, an outer peripheral surface of the leading end portion of the female terminal 11 is not in contact with an inner surface of the locking portion 13i, while the leading end portion of the female terminal 11 is inserted into the locking portion 13i. That is, in the present embodiment, the leading end portion of the female terminal 11 has an outer peripheral surface with a first outer diameter D2 smaller than an inner diameter D1 (see FIG. 18) of the locking portion 13i. In the present embodiment, the flange portion 11a1 is provided to protrude outward from the outer peripheral surface of the female terminal 11 in the radial direction.

Next, in the third inserting step (see FIG. 20) of the terminal holder 13, the leading end portion of the female terminal 11 is inserted into the stopper portion 13g. In this state, the outer peripheral surface of the leading end portion of the female terminal 11 is not in contact with an inner surface of the stopper portion 13g, while the leading end portion of the female terminal 11 is inserted into the stopper portion 13g. That is, in the present embodiment, the leading end portion of the female terminal 11 has a first outer diameter D2 smaller than an inner diameter of the stopper portion 13g. As a result, the female terminal 11 can be inserted into the stopper portion 13g without contacting the stopper portion 13g.

Next, in the fourth inserting step (see FIG. 21) of the terminal holder 13, the flange portion 11a1 formed on the outer peripheral surface of the female terminal 11 is locked by one end surface 13i1 of the locking portion 13i in the axial direction X and the other end surface 13g1 of the stopper portion 13g in the axial direction X. In this state, the flange portion 11a1 climbs over the locking portion 13i, so that the locking portion 13i returns to its free state, and the flange portion 11a1 is sandwiched between the locking portion 13i and the stopper portion 13g. In this state, the female terminal 11 is centered toward the center of the cylindrical portion 13a by the plurality of ribs 13h. At this time, in the present embodiment, the locking portion 13i and the stopper portion 13g provided in the upper region T1 described above are less likely to bend than the locking portion 13i provided in the lower region T2, so that the force for holding the female terminal 11 with respect to the terminal holder 13 is secured.

In the present embodiment, in a state between the third inserting step (see FIG. 20) and the fourth inserting step (see FIG. 21) of the terminal holder 13, the flange portion 11a1 formed on the outer peripheral surface of the female terminal 11 is inserted into the locking portion 13i. In this state, since the outer diameter of the flange portion 11a1 is larger than the inner diameter of the locking portion 13i, the abutment between the flange portion 11a1 and the locking portion 13i causes the locking portion 13i to bend outward of the cylindrical portion 13a in the radial direction. At this time, in the present embodiment, the locking portion 13i provided in the lower region T2 described above is easier to bend than the locking portion 13i provided in the upper region T1, so that the insertability of the female terminal 11 into the terminal holder 13 is secured as compared with that in a case where the bending amount of the locking portion 13i is equal between the upper region T1 and the lower region T2.

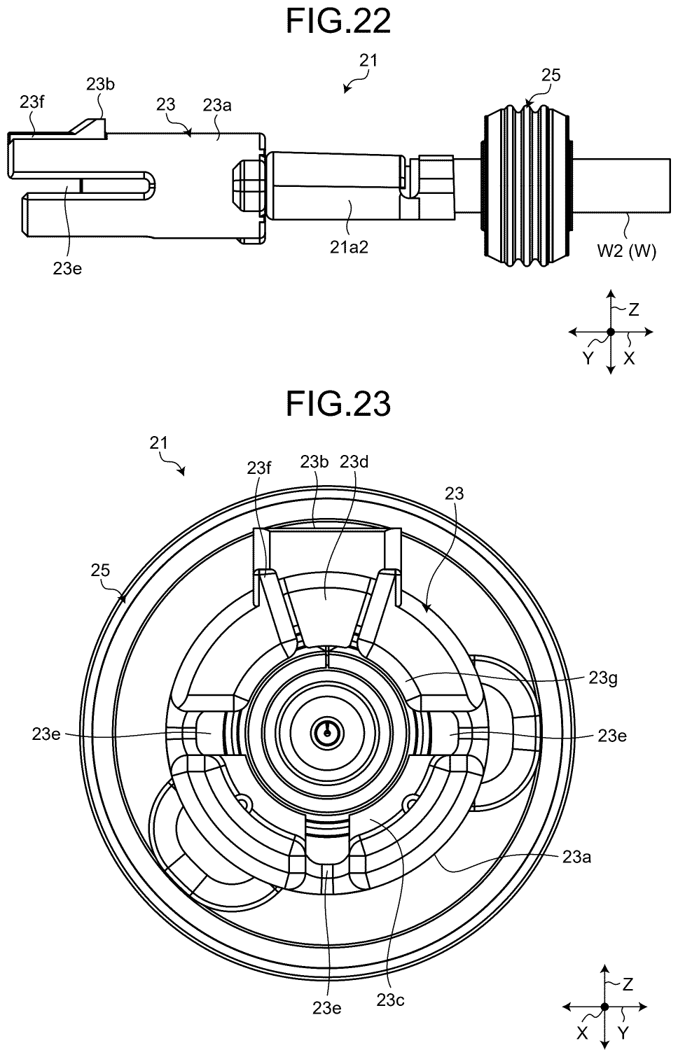

FIG. 22 is a side view of the male terminal 21 and the terminal holder 23 of the mating connector 20, and FIG. 23 is a front view of the male terminal 21 and the terminal holder 23 of the mating connector 20. As illustrated in FIGS. 22 and 23, in the present embodiment, the male terminal 21 is inserted into the terminal insertion hole 23c formed inside the terminal holder 23 along the axial direction X. At this time, in the terminal holder 23 in the present embodiment, similarly to the terminal holder 13, the upper region T1 on the first cutout portion 23d side is less likely to bend along the radial direction of the cylindrical portion 23a than the lower region T2 on the second cutout portion 23e side. The terminal holder 23 is constituted by the same components as the terminal holder 13.

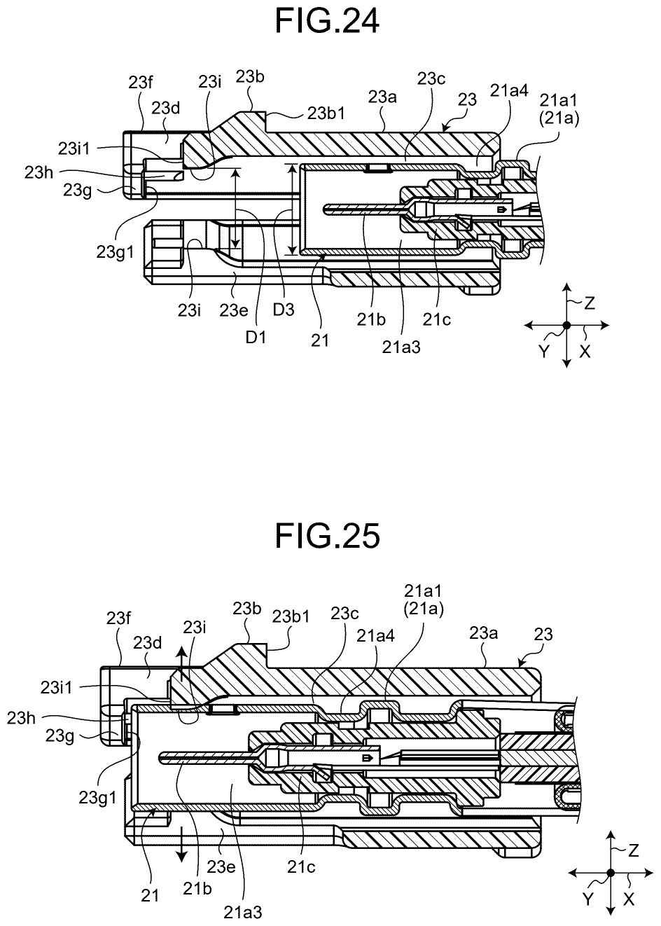

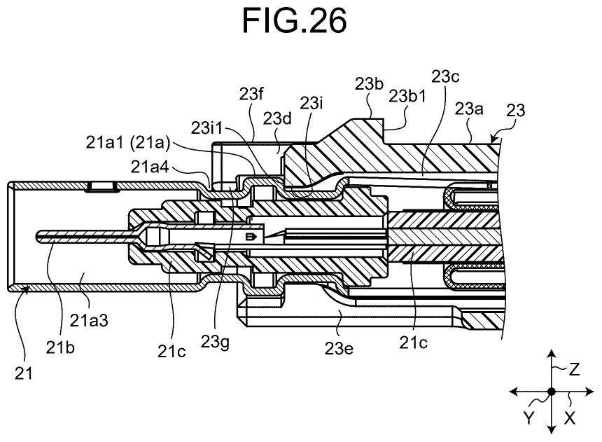

FIGS. 24 to 26 is cross-sectional views of the male terminal 21 and the terminal holder 23 of the mating connector 20, FIG. 24 is a view illustrating a first inserting step of the terminal holder 23, FIG. 25 is a view illustrating a second inserting step of the terminal holder 23, and FIG. 26 is a view illustrating a third inserting step of the terminal holder 23. First, in the first inserting step (see FIG. 24) of the terminal holder 23, the leading end portion of the male terminal 21 is inserted from the open end portion on one end side in the axial direction X of the terminal insertion hole 23c. In this state, the locking portion 23i and the leading end portion of the male terminal 21 are spaced apart from each other in the axial direction X.

Next, in the second inserting step (see FIG. 25) of the terminal holder 23, the leading end portion of the male terminal 21 is inserted into the locking portion 23i. In this state, an outer peripheral surface of the leading end portion of the male terminal 21 is in contact with an inner surface of the locking portion 231. That is, in the present embodiment, the outer peripheral surface of the leading end portion of the male terminal 21 has a second outer diameter D3 larger than an inner diameter D1 (see FIG. 24) of the locking portion 23i. In the present embodiment, the abutment between the leading end portion of the male terminal 21 and the locking portion 23i causes the locking portion 23i to bend outward of the cylindrical portion 23a in the radial direction. At this time, in the present embodiment, the locking portion 23i provided in the lower region T2 described above is easier to bend than the locking portion 23i provided in the upper region T1, so that the insertability of the male terminal 21 into the terminal holder 23 is secured as compared with that in a case where the bending amount of the locking portion 23i is equal between the upper region T1 and the lower region T2.

In the second inserting step (see FIG. 25) of the terminal holder 23, the abutment between the leading end portion of the male terminal 21 and the locking portion 23i causes the stopper portion 23g to bend outward of the cylindrical portion 23a in the radial direction together with the locking portion 23i. At this time, in the present embodiment, the pair of positioning ribs 23f extends along the axial direction X and is connected to the stopper portion 23g, thereby assisting the force for lifting the stopper portion 23g outward in the radial direction. As a result, the male terminal 21 can be inserted into the stopper portion 23g without bringing the leading end portion of the male terminal 21 into contact with the stopper portion 23g by picking up the stopper portion 23g.

Next, in the third inserting step (see FIG. 26) of the terminal holder 23, the flange portion 21a1 formed on the outer peripheral surface of the male terminal 21 is locked by the other end surface 23i1 of the locking portion 23i in the axial direction X and one end surface 23g1 of the stopper portion 23g in the axial direction X. In this state, the flange portion 21a1 climbs over the locking portion 23i, so that the locking portion 23i returns to its free state, and the flange portion 21a1 is sandwiched between the locking portion 23i and the stopper portion 23g. In this state, the male terminal 21 is centered toward the center of the cylindrical portion 23a by the plurality of ribs 23h. At this time, in the present embodiment, the locking portion 23i and the stopper portion 23g provided in the upper region T1 described above are less likely to bend than the locking portion 23i provided in the lower region T2, so that the force for holding the male terminal 21 with respect to the terminal holder 23 is secured. In the present embodiment, the outer diameter of the flange portion 21a1 is substantially the same as or slightly larger than the second outer diameter of the leading end portion of the male terminal 21.

As described above, in the connector 10 and the wire harness WH of the present embodiment, the terminal holder 13 includes a cylindrical portion 13a, cutout portions 13d and 13e provided at one end portion in the axial direction X of the cylindrical portion 13a and extending along the axial direction X, and a locking portion 13i provided at the one end portion in the axial direction X of the cylindrical portion 13a and protruding inward in the radial direction of the cylindrical portion 13a from the one end portion, one end surface 13i1 of the locking portion 13i in the axial direction X being locked by a flange portion 11a1 or 21a1 formed on an outer peripheral surface of one terminal, and the terminal holder 13 is commonly used between the female terminal 11 having an outer peripheral surface with a first outer diameter D2 smaller than an inner diameter D1 of the locking portion 13i, and a male terminal 21 having an outer peripheral surface with a second outer diameter D3 larger than the inner diameter D1. With this configuration, in the connector 10 and the wire harness WH, for example, even if the female terminal 11 and the male terminal 21 have different outer diameters, when the terminal is inserted into the terminal insertion hole 13c of the cylindrical portion 13a, the flange portion 11a1 or 21a1 comes into contact with the other end surface in the axial direction X of the locking portion 13i, and thereby, the cutout portions 13d and 13e act, and the locking portion 13i bends outward in the radial direction so that the terminal can be inserted to a locking position where one end surface 13i1 of the locking portion 13i in the axial direction X is locked by the flange portion 11a1 or 21a1. As a result, the terminal holder 13 can be commonly used in the connector 10 and the wire harness WH.

Further, in the connector 10 and the wire harness WH of the present embodiment, the terminal holder 13 includes a first cutout portion 13d provided in the upper region (first region) T1 of the cylindrical portion 13a, a second cutout portion 13e provided in the lower region (second region) T2 of the cylindrical portion 13a and having a larger length in the axial direction X than the first cutout portion 13d, a stopper portion 13g protruding inward of the cylindrical portion 13a in the radial direction from the upper region T1 and positioned to be spaced apart from the locking portion 13i in the axial direction X, the other end surface 13g1 of the stopper portion 13g in the axial direction X being locked by the flange portion 11a1 or 21a1, and a pair of positioning ribs 13f provided at both ends of the first cutout portion 13d in the width direction Y, protruding from the both ends outward of the cylindrical portion 13a in the radial direction, and aligned with the lance portion 12d formed inside the housing 12. With this configuration, in the connector 10 and the wire harness WH, for example, the locking portion 13i and the stopper portion 13g can be bent, with a difference in bending amount (deformation amount) between the upper region T1 and the lower region T2 of the cylindrical portion 13a, by the first cutout portion 13d and the second cutout portion 13e. As a result, in the connector 10 and the wire harness WH, both the insertability of the female terminal 11 into the terminal holder 13 and the force of the terminal holder 13 for holding the female terminal 11 can be secured.

In the connector 10 and the wire harness WH of the present embodiment, the pair of positioning ribs 13f extends along the axial direction X and is connected to the stopper portion 13g. With this configuration, in the connector 10 and the wire harness WH, for example, when the flange portion 11a1 or 21a1 abuts on the locking portion 13i of the upper region T1 and is bent outward in the radial direction, the pair of positioning ribs 13f is connected to the stopper portion 13g, thereby assisting the force of lifting the stopper portion 13g outward in the radial direction, and furthermore, acting to easily pick up the leading end portion of one terminal.

Although the embodiment of the present invention has been exemplified above, the above-described embodiment is merely an example, and is not intended to limit the scope of the invention. The above-described embodiment can be implemented in various other forms, and various omissions, substitutions, combinations, and changes can be made without departing from the gist of the invention. In addition, specifications such as configurations and shapes (structure, type, direction, form, size, length, width, thickness, height, number, arrangement, position, material, etc.) can be appropriately changed and implemented.

In the connector and the wire harness according to the present embodiment, the terminal holder includes cutout portions provided at one end portion in the axial direction of the cylindrical portion and extending along the axial direction, and a locking portion provided at one end portion in the axial direction of the cylindrical portion and protruding inward of the cylindrical portion in the radial direction from the one end portion in the axial direction of the cylindrical portion, one end surface in the axial direction of the locking portion being locked by a flange portion formed on an outer peripheral surface of the one terminal. With this configuration, in the connector and the wire harness, for example, even if the female terminal and the male terminal have different outer diameters, when the terminal is inserted into the terminal insertion hole of the cylindrical portion, the flange portion comes into contact with the other end surface in the axial direction of the locking portion, and thereby, the cutout portions act, and the locking portion bends outward in the radial direction so that the terminal can be inserted to a locking position where one end surface in the axial direction of the locking portion is locked by the flange portion. As a result, the terminal holder can be commonly used in the connector and the wire harness.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
one of a female terminal and a male terminal that extends along an axial direction;
a terminal holder that holds the one terminal; and
a housing that houses the one terminal and the terminal holder therein, wherein
the terminal holder includes:
a cylindrical portion in which a terminal insertion hole is provided to allow the one terminal to be inserted thereinto along the axial direction;
at least one cutout portion provided at one end portion in the axial direction of the cylindrical portion and extending along the axial direction; and
a locking portion provided at the one end portion in the axial direction of the cylindrical portion and protruding inward of the cylindrical portion in the radial direction from the one end portion in the axial direction of the cylindrical portion, one end surface in the axial direction of the locking portion being locked by a flange portion formed on an outer peripheral surface of the one terminal, and
the terminal holder is commonly used between the female terminal having the outer peripheral surface with a first outer diameter smaller than an inner diameter of the locking portion, and the male terminal having the outer peripheral surface with a second outer diameter larger than the inner diameter of the locking portion.

2. The connector according to claim 1, wherein
the at least one cutout portion includes:
a first cutout portion provided in a first region closer to one end portion than a central portion in a height direction intersecting the axial direction at the one end portion in the axial direction of the cylindrical portion, and extending along the axial direction; and
a second cutout portion provided in a second region closer to the other end portion than the central portion in the height direction at the one end portion in the axial direction of the cylindrical portion, extending along the axial direction, extending along the axial direction and having a larger length in the axial direction than the first cutout portion, and
the terminal holder further includes:
a stopper portion provided at the one end portion in the axial direction of the cylindrical portion, protruding inward of the cylindrical portion in the radial direction from the first region, and positioned to be spaced apart from the locking portion in the axial direction, the other end surface in the axial direction of the stopper portion being locked by the flange portion; and
a pair of positioning ribs provided at both end portions of the first cutout portion in a width direction intersecting the axial direction and the height direction, protruding outward of the cylindrical portion in the radial direction from the both end portions of the first cutout portion, and aligned with a lance portion formed inside the housing.

3. The connector according to claim 2, wherein
the pair of positioning ribs extends along the axial direction, and is connected to the stopper portion.

4. A wire harness comprising:
a wiring member having conductivity; and
a connector provided at an end of the wiring member, wherein
the connector includes:
one of a female terminal and a male terminal that extends along an axial direction;
a terminal holder that holds the one terminal; and
a housing that houses the one terminal and the terminal holder therein,
the terminal holder includes:
a cylindrical portion in which a terminal insertion hole is provided to allow the one terminal to be inserted thereinto along the axial direction;
at least one cutout portion provided at one end portion in the axial direction of the cylindrical portion and extending along the axial direction; and
a locking portion provided at the one end portion in the axial direction of the cylindrical portion and protruding inward of the cylindrical portion in the radial direction from the one end portion in the axial direction of the cylindrical portion, one end surface in the axial direction of the locking portion being locked by a flange portion formed on an outer peripheral surface of the one terminal, and
the terminal holder is commonly used between the female terminal having the outer peripheral surface with a first outer diameter smaller than an inner diameter of the locking portion, and the male terminal having the outer peripheral surface with a second outer diameter larger than the inner diameter of the locking portion.
